(19) United States
(12) Patent Application Publication
(10) Pub. No.: US 2025/0334220 A1
(43) Pub. Date: Oct. 30, 2025

(54) FLOATING PIPELINE INSPECTION DEVICE

(71) Applicant: PICA Pipeline Inspection and Condition Analysis Corporation, Edmonton (CA)

(72) Inventors: David Edward Russell, Sherwood Park (CA); David Michael Burton, Edmonton (CA); Dmitri Ivanovich Shilov, Edmonton (CA)

(73) Assignee: PICA Pipeline Inspection and Condition Analysis Corporation, Edmonton (CA)

(21) Appl. No.: 19/184,825

(22) Filed: Apr. 21, 2025

Related U.S. Application Data
(60) Provisional application No. 63/638,244, filed on Apr. 24, 2024.

(51) Int. Cl. F16L 55/46; F16L 101/30; G01F 1/05; G01M 3/24

(52) U.S. Cl. CPC F16L 55/46; G01F 1/05; F16L 2101/30; G01M 3/246

(57) ABSTRACT

A system for inspecting the condition of a conduit while fluid is flowing in the conduit includes an inspection apparatus and a retrieval unit insertable into the conduit for catching the apparatus and removing the apparatus from the conduit. The inspection apparatus includes first and second chambers interconnected together in spaced apart relationship, one of the chambers is positively buoyant and the other chamber is negatively buoyant. Sensing devices to detect and sense physical parameters of at least one of the fluid and the conduit are disposed within at least one of the first and second chambers. The retrieval unit includes a catchment device shaped to capture the apparatus and a deployment device to deploy the catchment device to be in position to catch the inspection apparatus. Once the inspection apparatus is caught, the deployment device removes the inspection apparatus from the conduit.

### CROSS-REFERENCE TO RELATED APPLICATION

This application claims the benefit of U.S. Provisional Application No. 63/638,244, filed Apr. 24, 2024, the entire contents of which are incorporated herein by reference.

### BACKGROUND

Small, free-floating or free-swimming devices have been used in pipelines and conduits for water, waste-water, oil and other liquids to detect a variety of conditions that can lead to failure of the conduit or pipeline. One such type of device is known as a leak-detection device. These devices measure the noise made by leaks, internal pressure variations, the noise created by the presence of gas pockets, magnetic memory of the pipe wall and/or other characteristics of the conduit or pipeline.

In large diameter conduits and pipelines, the flow inside the conduit/pipeline is often in the order of at least 5 feet per second. At this flow speed it is very difficult to catch the condition-assessment devices with a net because the net has to withstand the force of the flow within the pipeline and will often be damaged or destroyed by the flow.

The disclosure of the present application seeks to provide an apparatus and system that includes devices for detecting numerous physical parameters of the conduit/pipeline, while being readily retrievable from the interior of the conduit/pipeline.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In general terms, the current disclosure pertains to an apparatus and system that measures various physical characteristics of a conduit or pipeline to help determine its fitness for service, while also solving the problem of retrieving the apparatus from the interior of the conduit or pipeline by introducing a novel feature of the present system to capture the apparatus. The apparatus of the present disclosure incudes two spaced apart hollow chambers or spheres, each containing detectors, sensors, transmitters, recorders, batteries, etc., with one chamber being positively buoyant and the other chamber being negatively buoyant.

It is noted that as in some past pipeline detection systems, if the detection system consists of a single chamber that is positively buoyant, the positively buoyant chamber can become trapped in an appurtenance that is located on the top of the pipeline, such as a manhole. The current disclosure seeks to solve that problem by having the negative buoyancy of the lower chamber counteract the positive buoyancy of the upper chamber and therefore preventing the upper chamber from rising into a manhole or other appurtenance located at the top of the pipeline.

The flow in any given pipeline is slower near the walls of the pipeline due to friction between the flow and the pipeline wall, and the flow is fastest at the center of the pipeline or the center of the elevation of the flow. By controlling the length of the distance that separates the two chambers of the detection device, the lower chamber can be positioned close to the center of the pipeline while the upper chamber trails behind the lower chamber at the top of the pipeline. In the event that the upper chamber does float or otherwise flow into a manhole, or other large appurtenance located at the top of the pipeline, the stronger flow at the center of the pipeline will pull the upper chamber out of the appurtenance.

In accordance with one embodiment of the present disclosure, an inspection apparatus to inspect the condition of a conduit is provided, the inspection apparatus flowing with a fluid within the conduit. The inspection apparatus includes:
first and second chambers interconnected together in spaced apart relationship, one of the chambers is positively buoyant and the other chamber is negatively buoyant;
sensing devices to detect and sense physical parameters of at least one of the fluid and the conduit are disposed within at least one of the first and second chambers.

In any of the embodiments described herein, wherein the sensing devices are disposed within both the first and second chambers.

In any of the embodiments described herein, further comprising additional devices to operate the sensing devices, the additional devices comprising at least one of a signal transmitter, a data signal transmitter, a beacon signal generator and transmitter, a light transmitter, a data recorder, and a power supply disposed in at least one of the first and second chambers.

In any of the embodiments described herein, wherein the sensing devices are selected from the group consisting of: an acoustic leak noise detector; an ultrasonic wall thickness transducer; a fluid pressure sensor; a temperature sensor; a CCTV camera; inertial measurement units; sonar equipment; LiDAR equipment; electromagnetic sensors to measure residual magnetic memory; speedometer; odometer.

In any of the embodiments described herein, further comprising a connector for interconnecting the first and second chambers at a fixed distance from each other.

In any of the embodiments described herein, wherein the connector is substantially rigid.

In any of the embodiments described herein, wherein the connector is of a length that when the apparatus is moving with the flowing fluid in the conduit, the negatively buoyant chamber is approximate at the vertical center of the flowing fluid.

In any of the embodiments described herein, wherein the connector is adjustable in length.

In any of the embodiments described herein, wherein the connector at its juncture with the negatively buoyant chamber is aligned away from the centroid of the negatively buoyant chamber.

In any of the embodiments described herein, wherein at least one of the chambers further comprises a tapered gusset structure functioning as a transition between the at least one chamber and the connector.

In any of the embodiments described herein, further comprising a keel structure located at or near the negatively buoyant chamber to assist in aligning the apparatus relative to the direction of the flow in the conduit.

In any of the embodiments described herein, further comprising removable ballast disposable in the negatively buoyant chamber.

In any of the embodiments described herein, wherein one or both of the chambers are of a shape selected from the group consisting of a sphere, spheroid, prolate spheroid, oblate spheroid, ovoid, platonic sphere, polyhedron, octahedron, dodecahedron, icosahedron.

In any of the embodiments described herein, further comprising an odometer/speedometer wheel rotatable relative to the positively buoyant chamber to project beyond the exterior of the positively buoyant chamber.

In any of the embodiments described herein, wherein the positively buoyant chamber comprises two sections and the odometer wheel is disposed between the two sections of the positively buoyant chamber.

In any of the embodiments described herein, further comprising an encoder associated with the odometer wheel to sense the distance travelled by the apparatus.

In accordance with one embodiment of the present disclosure, a system for inspecting the condition of a conduit while fluid is flowing in the conduit is provided. The system includes an inspection apparatus and a retrieval unit insertable into the conduit for catching the inspection apparatus and removing the inspection apparatus from the conduit.

In any of the embodiments described herein, wherein the retrieval unit comprises a catchment device shaped to capture the inspection apparatus, and a deployment device to deploy the catchment device across the width of the conduit near the top of the flow level of the fluid flowing through the conduit.

In any of the embodiments described herein, wherein the catchment device comprises a hook with diverging prongs, the prongs diverging from a juncture.

In any of the embodiments described herein, wherein the prongs are spaced apart at the juncture at a width narrower than the width of the positively buoyant chamber.

In any of the embodiments described herein, wherein the retrieval unit comprises a housing structure connectable to an opening in the conduit to extend transversely from the conduit, the catchment device nominally disposable in the housing.

In any of the embodiments described herein, wherein the deployment device is operable to move the catchment device along the housing structure and into the conduit to position the catchment device near the top of the flow level of the fluid flowing through the conduit, and to remove the catchment device and captured devices from the conduit and into the housing structure.

In any of the embodiments described herein, wherein the housing structure comprises an aperture to view into the interior of the housing structure.

In accordance with one embodiment of the present disclosure, a kit for inspecting the condition of a conduit while fluid is flowing in the conduit is provided, the kit including an inspection apparatus and a portable storage and carrying cradle. The cradle includes pockets for snugly receiving and holding the chambers of the inspection apparatus, and an electrical charging system for charging the sensing devices and additional devices disposed in one or both of the negatively and positively buoyant chambers.

In any of the embodiments described herein, wherein the electrical charging system is configured to automatically begin charging the sensing devices and additional devices when the negatively and/or positively buoyant chambers are placed in the pockets of the cradle.

In any of the embodiments described herein, further comprising a non-functional inspection apparatus devoid of sensing devices and additional devices, with the exception of at least one of a beacon signal generator and transmitter and a light transmitter.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A is a pictorial view of an inspection apparatus of the present disclosure;

FIG. 1B is a view similar to FIG. 1A, but with the inspection apparatus rotated ninety degrees;

FIG. 2 is a pictorial view of the inspection apparatus similar to FIG. 1A, showing sensing devices and additional devices in the chambers of the inspection apparatus;

FIG. 3A is an enlarged pictorial view the sensing devices and additional devices shown in the upper floating chamber of FIG. 2;

FIG. 3B is an enlarged pictorial view of the sensing devices and additional devices shown in the lower submerged chamber of FIG. 2;

FIG. 4 is a pictorial view showing the retrieval unit for retrieving the inspection apparatus, with the catching device of the retrieval unit stored within a housing structure;

FIG. 5 is a view similar to FIG. 4, with the catching device partially deployed into the pipeline by the deployment unit;

FIG. 6 is a view similar to FIG. 5, with the catching device deployed within the pipeline to extend across the upper portion of the pipeline and an inspection apparatus flowing in the pipeline toward the catching device;

FIG. 7 is a view similar to FIG. 6 showing the inspection apparatus engaged with the catching device;

FIG. 8 is an enlarged fragmentary view of FIG. 7 showing the inspection apparatus fully engaged with the catching device;

FIG. 9 is the view similar to FIG. 7 with the catching device and the inspection apparatus captured thereby partially raised into the housing structure by the deployment device;

FIG. 10 is the view similar to FIG. 9 with the catching device and the inspection apparatus captured there by fully raised within the housing structure by the deployment device;

FIG. 11 illustrates a kit according to the present disclosure wherein the inspection apparatus is disassembled and stored within a storage unit/cradle;

FIG. 12 is the view similar to FIG. 11 showing the charging system incorporated into the storage unit for charging the inspection apparatus;

FIG. 13A is an enlarged pictorial view showing the disassembly of a chamber;

FIG. 13B is an enlarged pictorial view show a disassembled chamber;

FIG. 14 is an enlarged pictorial view of a chamber showing buoyancy weights;

FIG. 15 is an enlarged cross-sectional view of a dummy chamber showing buoyancy weights.

### DETAILED DESCRIPTION

The description set forth below in connection with the appended drawings, where like numerals reference like elements, is intended as a description of various embodiments of the disclosed subject matter and is not intended to represent the only embodiments.

Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to “directions,” such as “forward,” “rearward,” “front,” “back,” “ahead,” “behind,” “upward,” “downward,” “above,” “below,” “horizontal,” “vertical,” “top,” “bottom,” “right hand,” “left hand,” “in,” “out,” “extended,” “advanced,” “retracted,” “proximal,” and “distal.” These references and other similar references in the present application are only to assist in helping describe and understand the present disclosure and are not intended to limit the present invention to these directions.

The present application may include modifiers such as the words “generally,” “approximately,” “about,” or “substantially.” These terms are meant to serve as modifiers to indicate that the “dimension,” “shape,” “temperature,” “time,” or other physical parameter in question need not be exact but may vary as long as the function that is required to be performed can be carried out. For example, in the phrase “generally circular in shape,” the shape need not be exactly circular as long as the required function of the structure in question can be carried out.

In the present application, the terms “conduit” and “pipeline” are used synonymously. Also, in the present application the terms “chamber” and “shell” are used synonymously.

In the following description and in the accompanying drawings, corresponding systems, assemblies, apparatus, and units may be identified by the same part number, but with an alpha suffix. The descriptions of the parts/components of such systems assemblies, apparatus, and units that are the same or similar are not repeated so as to avoid redundancy in the present application.

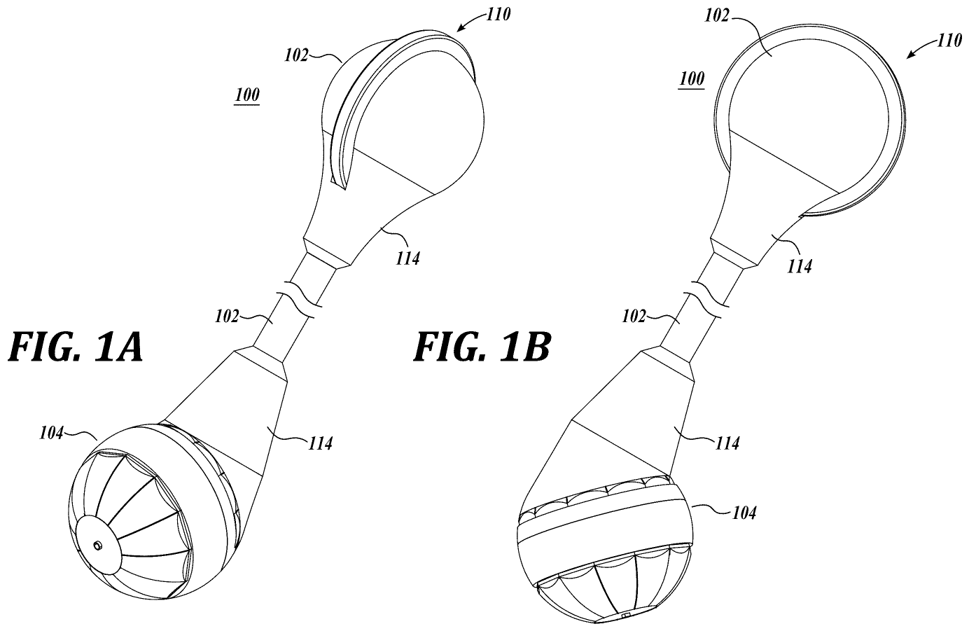

Referring initially to FIGS. 1-3, 7, and 8, an inspection system 90 for inspecting the condition of a fluid transporting conduit or pipeline 92 includes in basic form an inspection apparatus 100 that flows with the fluid moving in the conduit or pipeline to sense and detect the physical parameters of the fluid and/or pipeline. The fluid can be of numerous forms, including for example, water, potable water, wastewater, effluent, including from manufacturing mining or other processing systems, oil, propane, butane, pentane and other liquids.

The inspection apparatus 100 includes a first shell or chamber 102 that is positively buoyant (floating) and a second shell or chamber 104 that is negatively buoyant (submerged), with the two shells/chambers spaced apart from each other. Sensing devices to detect and sense physical parameters of at least one of the fluid and the conduit are disposed within at least one of the first and second shells/chambers. Additional devices to operate the sensing devices, and for other purposes, may also be disposed with the first and/or second shells/chambers.

A connector 106 interconnects the two chambers at a distance so that the positively buoyant chamber 102 is disposed at or near the top of the flowing fluid and the negatively buoyant changer is disposed near the vertical center of the flowing fluid.

As can be appreciated, if the pipeline 92 is full of fluid, or nearly full of fluid, the positively buoyant chamber 102 will move along the upper wall of the pipeline and the length of the connecter 106 is selected so that the negatively buoyant chamber 104 is submerged at or close to the center of the pipeline.

The reason for this configuration or geometry for the inspection apparatus 100 is because the flow of the fluid in any given pipeline is slower near the walls of the pipeline due to friction between the fluid flow and the pipeline wall, and the fluid flow is fastest at the center of the pipeline or the center of the elevation of the fluid flow. By controlling the length of the distance that separates the two chambers 102 and 104 of the inspection apparatus 100, the lower chamber 104 can be positioned close to the center of the pipeline flow while the upper chamber 102 trails behind the lower chamber at or near the top of the pipeline 92. In the event that the upper chamber does float or otherwise flow into a manhole, or other large appurtenance or pocket located at the top of the pipeline 92, the stronger fluid flow at the center of the pipeline will pull the upper chamber 102 out of the appurtenance or pocket. As such, the inspection apparatus 100 will not become lodged or otherwise stuck in the appurtenance, as could be the case if the inspection apparatus were composed of single buoyant chamber.

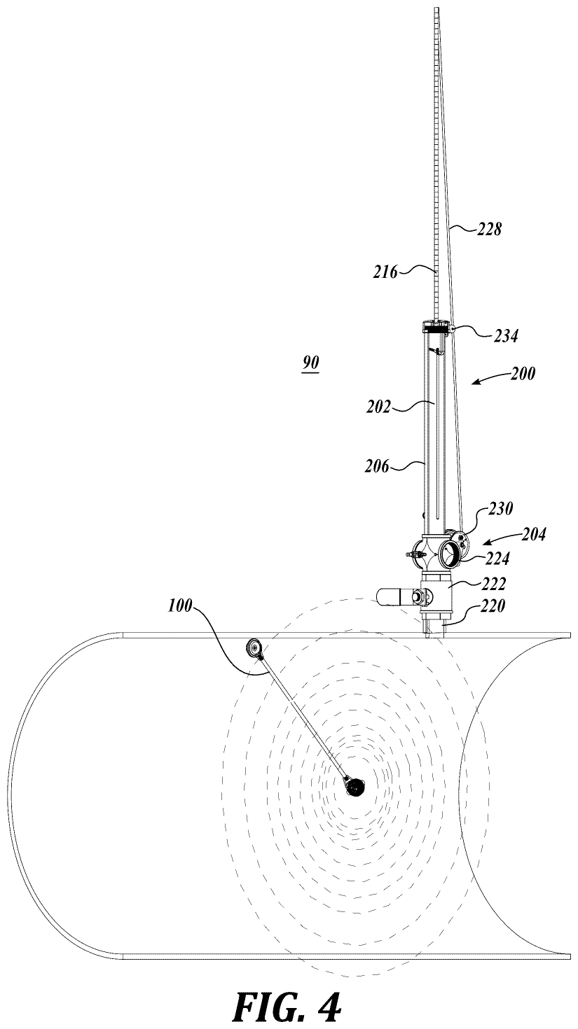

The inspection system 90 also includes a retrieval unit 200 for retrieving the inspection apparatus 100 from the pipeline flow, as shown in FIGS. 4-10. In basic form the retrieval unit 200 includes a catchment device 202 that is shaped to capture the inspection apparatus 100 when the catchment device is deployed into the pipeline 92 by a deployment device 204. The deployment device is nominally disposed in a housing structure 206 that is connectable to the pipeline 92 to extend transversely to the pipeline. When in use, the deployment device 204 deploys the catchment device 202 to extend across the width of the pipeline 92 near the top of the flow level of the fluid flowing through the pipeline. In this position, the catchment device 202 captures the inspection apparatus 100 just below the upper chamber 102. Thereafter, the deployment device 204 is operable to remove the catchment device 202, together with the inspection apparatus 100, from the pipeline 92 and into the housing structure 206.

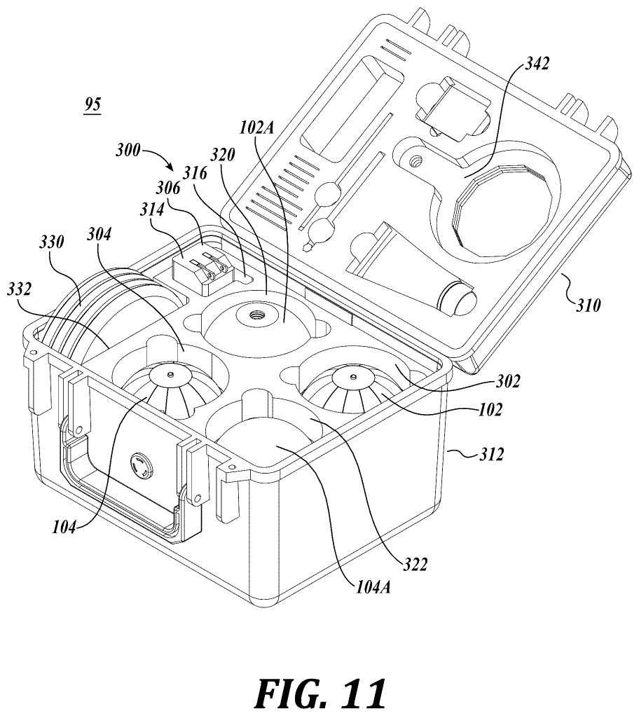

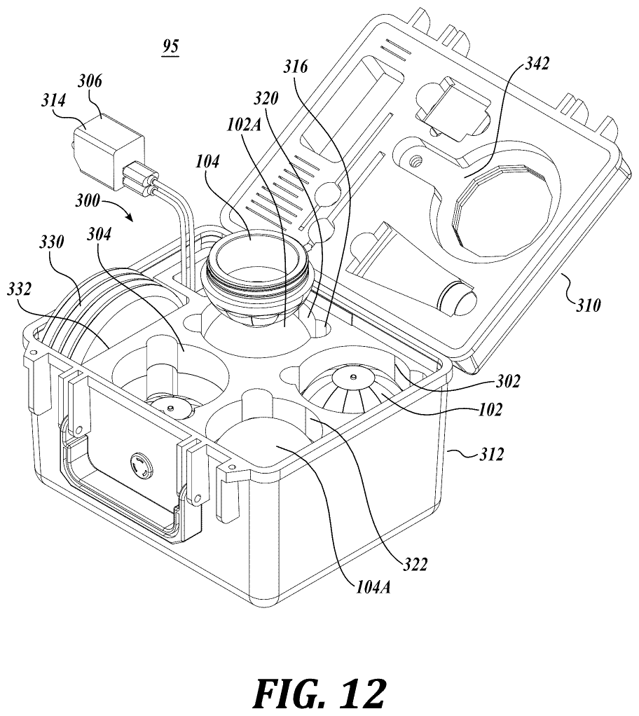

The present disclosure also includes a kit 95 that is basic form includes the inspection apparatus 100, as well as portable storage unit or cradle 300. In this regard, see FIGS. 11 and 12. The storage unit/cradle 300 includes pockets 302 and 304 for snugly receiving and storing the chambers 102 and 104 of the inspection apparatus 100 therein. The storage unit/cradle 300 also includes an electrical charging system 306 that automatically begins to recharge the batteries 162 band other rechargeable components in the chambers 102 and 104 as soon as the chambers are placed into the pockets 302 and 304.

It is to be understood that the system 90 and kit 95 may not include all of the components and features noted above. Rather the system 90 and kit 95 are capable of successfully functioning with only a portion of the components and features noted above and more fully described below.

Next describing the inspection system 90 and kit 95 in greater detail, referring specifically to FIGS. 1-3, the inspection apparatus 100, as noted above, is constructed with spaced apart, positively and negatively buoyant chambers 102 and 104, respectively, that are separated at a fixed distance apart by a rigid or semi-rigid or flexible connector or staff 106. The chambers 102 and 104 are constructed similarly in shape but need not be exactly of the same shape, as described below.

Nonetheless, both chambers 102 and 104 are generally spherical in shape. The size of the two chambers can be the same or nearly the same, but their sizes can be varied depending on various factors, including, for example, the diameter of the pipeline being inspected, the flow rate of the fluid flowing in the pipeline, the viscosity of the fluid flowing in the pipeline, the volume required by the sensing devices and other devices disposed within the chambers 102 and 104. Further, the sizes of the chambers 102 and 104 can be varied individually or relative to each other.

The chambers 102 and 104 can be of other shapes rather than being spherical or generally spherical. For example, in addition to be spherical or generally spherical in shape, the chambers can be in or generally in the shape of a spheroid, prolate spheroid, oblate spheroid, ovoid, platonic sphere, polyhedron, octahedron, dodecahedron, icosahedron, etc.

The chambers 102 and 104 can be composed of any suitable material that is fluid tight, durable, resistant to abrasion, and formable or moldable to the desired shape of the chambers 102 and 104. A non-limiting example of such a material is carbon fiber-based materials. Other suitable materials may include, for example, silicon or Kevlar or similar fiber-based or reinforced materials.

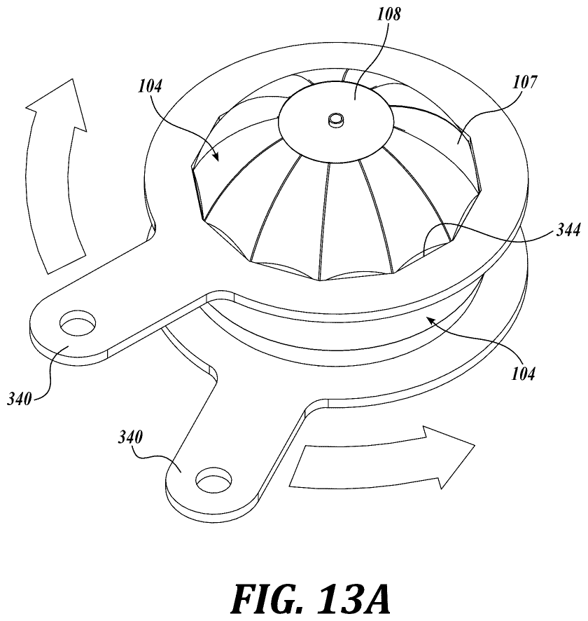

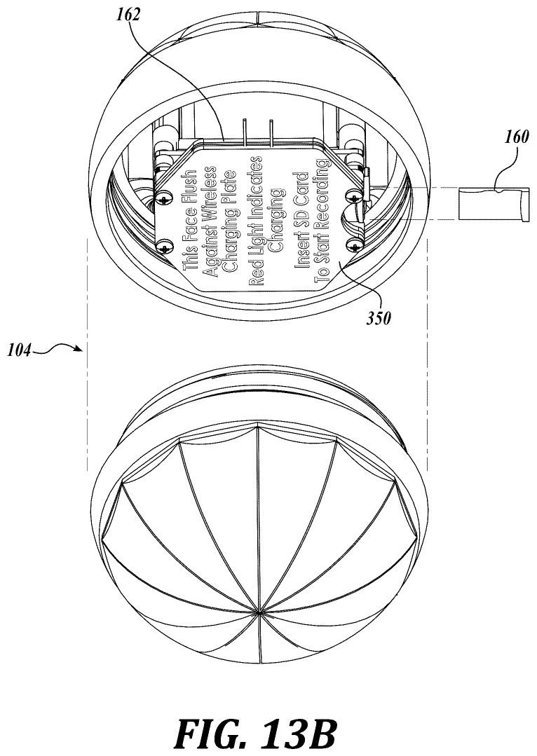

In construction, the chambers can be composed of or divided into generally triangularly shaped segments 107 that increase in width from a circular center 108 at the distant poles of the chamber to the equator of the chambers, see FIG. 13A. In this regard, the chamber can be constructed from two generally semispheres that are joined together by a threaded joint at the equator of the chambers. One semisphere of the chamber is formed with male threads that engage female threads of the other semisphere of the chamber. Of course, other types of joints or methods can be used to join the semispheres.

By the forging construction, the chambers 102 and 104 can be opened, as shown in FIGS. 13A and 13B, to provide access to the components within the chambers, including weights to adjust the buoyancy of chamber 104 or memory cards 160 used to store data from the sensing devices.

As noted above, the chambers 102 and 104 are interconnected together by a rigid connector or staff or shaft 106. The length of the connector 106 is selected so that when the inspection apparatus 100 is in use, the lower chamber 104 is positioned close to the center of the pipeline flow while the upper chamber 102 trails behind the lower chamber at or near the top of the pipeline flow. For a pipeline that is filled by the flowing fluid, the upper chamber will slide along the upper surface of the pipeline. To meet this criteria, the length of the connector 106 will vary depending on various factors including, for example, the diameter of the pipeline, the speed of the flow through the pipeline, the level of the flow through the pipeline, the viscosity of the fluid flow through the pipeline.

The connector 106 can be constructed to be disconnectable from the chambers 102 and 104, so that an appropriate length connector can be employed. Alternatively, the connector 106 can be constructed to be adjustable in length. In this regard, the connector 106 can be of telescoping construction. Once the desired separation between the chambers 102 and 104 is achieved, the telescoping sections of the connector 106 can be securely locked together to maintain the desired separation.

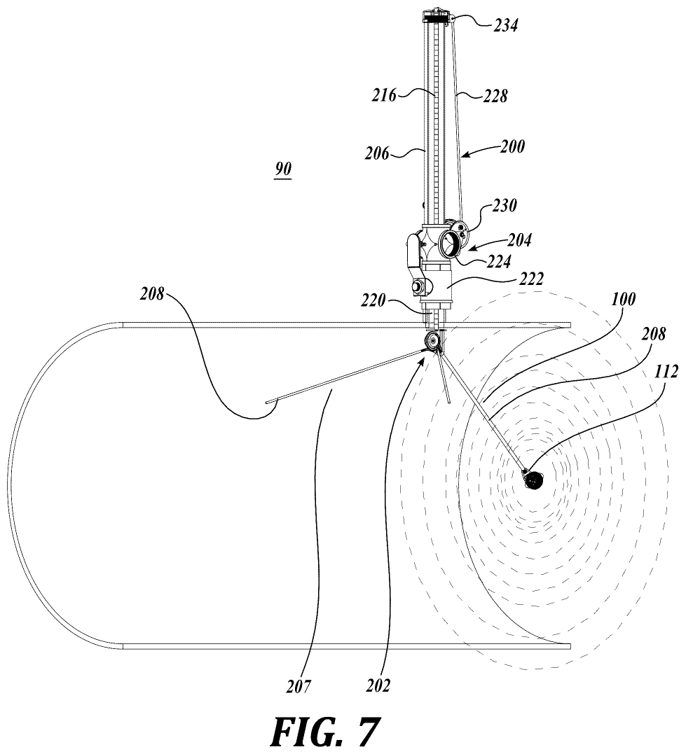

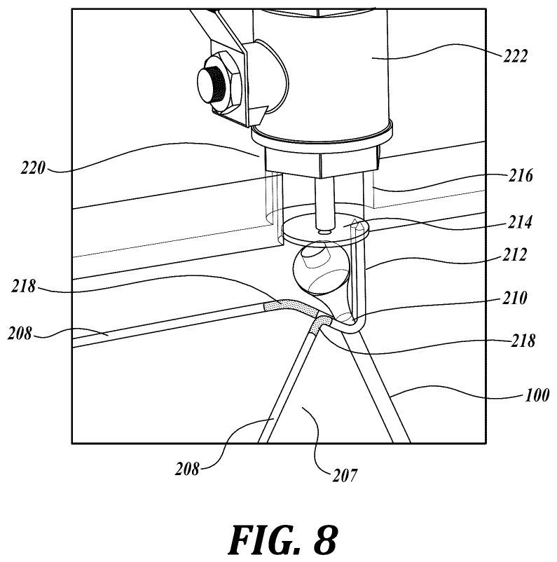

The inspection apparatus 100 can be constructed so that the yaw of the apparatus about the length of the connector 106, and thus also relative to the length of the pipeline can be minimized or otherwise controlled. To this end, the connector 106 can be joined to the negative buoyant chamber 104 along an axis that is offset to be below the centroid of the chamber 104 when the apparatus is in use, see FIG. 1B. As a result, as shown in FIGS. 7 and 8, when the apparatus 100 is in use the negatively buoyant chamber 104 leads the positively buoyant chamber 102 in the direction of the flow in the pipeline 92. (In FIG. 1B, this is in the left hand direction.) Also, the connector is tilted at an angle relative to the vertical while disposed in a vertical plane extending along the length of the pipeline. In this orientation of the inspection apparatus 100, a rotating odometer wheel 110, discussed below, tracks in a longitudinal line or path extending along the top wall of the pipeline 92 so the distance of travel and speed of the inspection apparatus can be measured.

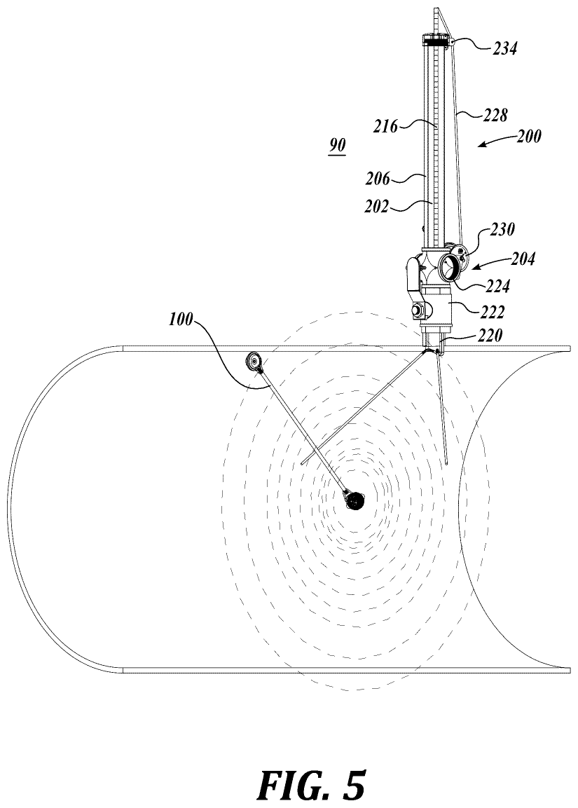

In addition to, or as an alternative to, connecting the connector 106 to the lower chamber 104 in the manner described above, a keel 112 can be mounted to the lower chamber, to the connector 106, or to both the connector 106 and the chamber 104 as shown in FIGS. 5-7 The keel projects from the lower chamber and/or the connector in the direction downstream to the flow. The flow of the fluid past the keel 112 will help maintain the desired orientation of the inspection apparatus 100 relative to the pipeline 92.

The keel can be of various shapes and sizes and perform its desired function, which is not limited to the keel 112 shown in FIGS. 5-7. For example, the keel need not be of planar shape, but can be tapered across its width. Also, the keel can be incorporated into the construction of the gusset structure 114 which interconnects the connector 106 to the chambers 102 and 104 as discussed next below.

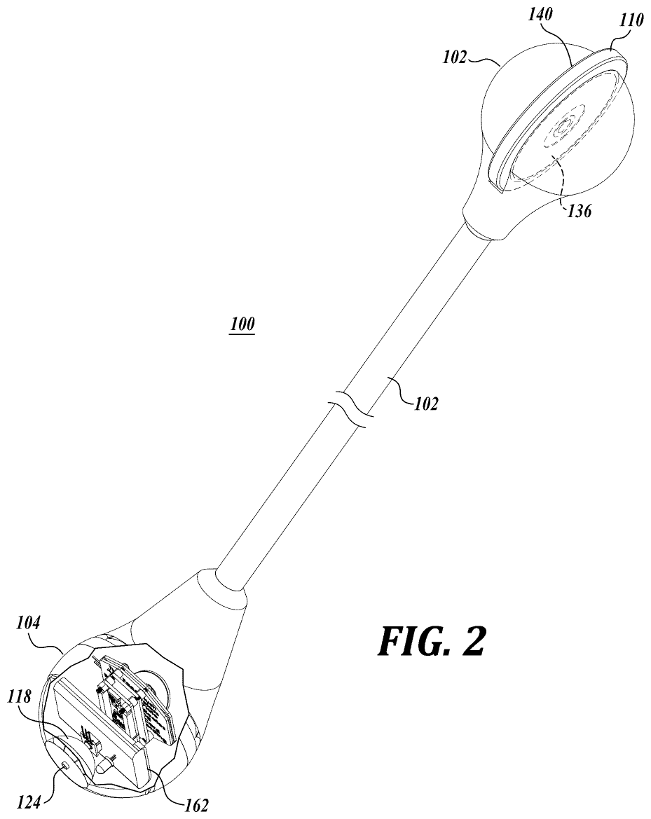

Referring specifically to FIGS. 1 and 2, tapered, generally cone-shaped gusset structures 114 are used to join the connector 106 to the chambers 102 and 104. The larger ends of the gusset structures 114 can be affixed to the chambers 102 and 104, and then the ends of the connector 106 connected to the gusset structures. As a result, a durable connection of high structural integrity is achieved between the connector 106 and the chambers 102 and 104.

As noted above, various sensing devices are disposed within or incorporated into the positive and negative buoyancy chambers 102 and 104. The sensing devices may include, without limitation, an acoustic leak noise detector 118, an ultrasonic wall thickness transducer 120, a fluid pressure sensor 122. A CCTV camera 126, inertial measurement units 128, sonar equipment 130, LiDAR equipment 132, electromagnetic sensors 134 to measure residual magnetic memory, a speedometer/odometer 136.

Briefly discussing these sensing devices, an acoustic leak detector 118 can detect leaks in the pipeline 92. The detector can be incorporated in to either or both the two buoyancy chambers. When fluid under pressure leaks through a cracked or otherwise damaged pipe or conduit, a specific low pitch sound may be produced. This sound is caused by the vibration of the leak traveling down the pipeline. Thus, the acoustic leak detector includes a microphone tuned to detect tones of the frequencies produced by the leading fluid. Filters may be used to filter out ambient noises. The filter(s) can be on board the chambers 102 and/or 104 or may be located external to the chambers.

The acoustic detector can also be used to identify gas pockets. Gas pockets sound like a long area of continuous bubbles caused by the interaction of the trapped gases and the liquid passing through the area. The gas pocket noises are distinct from leak noises and impact noises of for example, the inspection apparatus striking the pipeline, and can be identified by their acoustic spectrum and duration.

The fluid pressure sensor 122 can also be used to detect a fluid leak. The pressure of the fluid at or near the leak can be at a lower level than the pressure of the fluid at locations away from the leak.

An ultrasonic transducer 126 can be used to measure the thickness of the pipeline wall to look for flaws, thin wall locations, cracks, corrosion, weld bead porosity, erosion of the pipeline material due to turbulence in the fluid being transported and other physical features and anomalies of the pipeline. A high voltage pulse or ultrasound is generated by piezoelectric crystal in ultrasonic transducer. The ultrasound wave will propagate into the pipeline being tested through the liquid medium in the pipe. The length of the liquid column between the transducer and inside of the pipe is variable as the device moves around in the pipeline with the flow; however, the arrival of the reflection from the pipe inside diameter (ID) triggers a timing circuit that measures the amount of time between the ID signal and one from the pipe outside diameter (OD). The difference in transit time is converted to metal or plastic thickness to record the remaining wall thickness of the pipe at the numerous points where readings are obtained.

The CCTV camera 126 can be used to visually view the condition of the interior of the pipeline walls as well as the condition of welds, fittings, joints, and other features of a pipeline. The CCTV camera can also show debris or foreign material or matter in a pipeline, for example, at a juncture or other discontinuity within the pipeline.

The inertia measurement units 128 measure the speed variation of the inspection apparatus 100 flowing through the pipeline 92. The speed variations can indicate if the pipeline 92 is restricted in any way, for example, due to deposits inside the pipeline. The inspection apparatus would speed up at the locations of such restrictions.

The sonar devices 130 can be used to measure the internal diameter of the pipeline, and the LiDAR equipment 132 can be used to map the internal surfaces of the pipeline, connectors, junctions, etc.

Electromagnetic sensors 134 can be used for measuring residual magnetic memory. The earth's magnetic field gets concentrated in the steel wall of the pipeline and there are small variations in that magnetic field at welds and joints. It is useful to detect joints because they are generally located at standard lengths (for example, at 20 feet apart). If the joints are detected, it is possible to measure how far apart the signals are. This provides one more way to calculate the speed and distance of travel of the inspection apparatus, and thus the flow in the pipeline.

Also, the direction of the pipeline with respect to the Earth's magnetic field affects how well joints can be detected by the electromagnetic sensors. If the pipe runs North-South (aligned with the Earth's magnetic field), the electromagnetic sensor system works best. If the pipe runs East-West, then it may not be possible to detect the joints at all. For this reason, the electromagnetic detector is placed into the “floating” chamber so that the detector should always be in contact with the top of the pipe, thereby providing better sensitivity.

As shown in FIGS. 1 and 2, a speedometer/odometer 136 is built into the upper chamber 102. The speedometer/odometer 136 includes a wheel 110 axled to the upper chamber, between two sections of the chamber. The wheel 110 projects beyond the outer surface of the upper chamber so that the perimeter of the wheel 110 can roll along the underside at the top of the pipeline 92. A magnetic encoder system 140 is provided to sense the speed of rotation and the number of rotations of the wheel. In this manner, the speed that the inspection apparatus 100 is moving along the pipeline can be measured and monitored, as well as the distance traveled by the inspection apparatus. Magnetic encoder systems are articles of commerce.

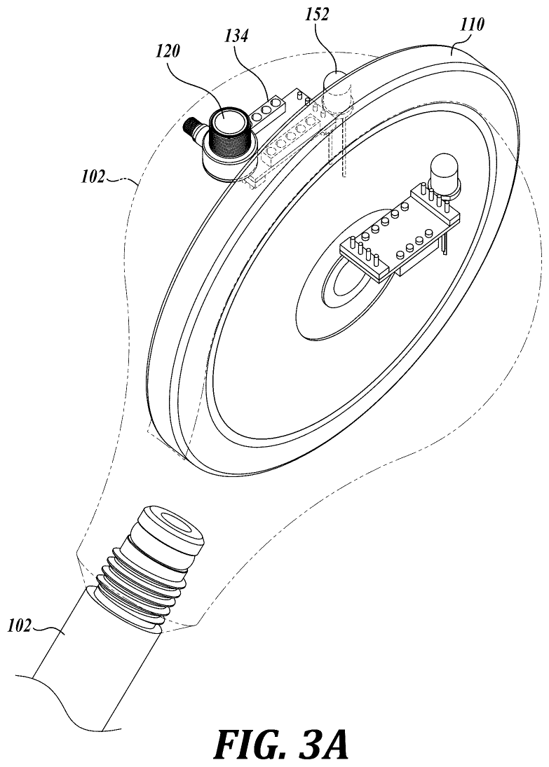

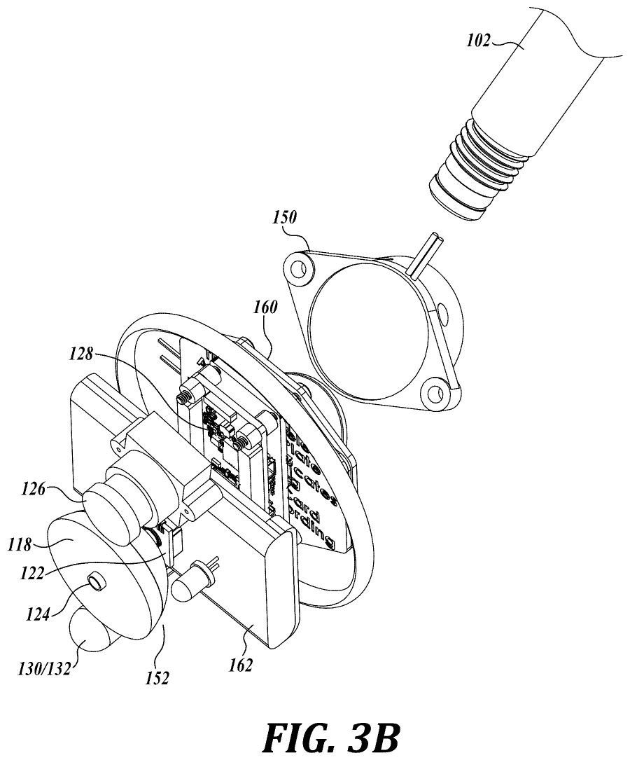

As also noted above and as shown in FIGS. 3A and 3B, additional devices may be disposed in the chambers 102 and/or 104 to operate the sensing devices or for other purposes. The additional devices may include at least one of a signal transmitter, a data signal transmitter, a beacon signal generator, and transmitter 150; a light transmitter 152; a data recorder, and a power supply disposed in at least one of the first and second chambers 102 and 104. Various types of signal transmitters 150 can be on board the chambers 102 and/or 104, for example, one or more data transmitters to transmit data from the various sensing devices noted above.

Alternatively, or in addition, the data from the sensing devices can be stored in a data recorder located in one or both of the chambers 102 and 104. The data recorder can be in the form of a solid state memory device, such as an SD card 160, that can conveniently be removed from the chamber within which the card is located. Alternatively, data from the memory device can be transmitted to an external receiver while the inspection apparatus 100 is operating or after the apparatus has been retrieved from the pipeline.

Another “additional device” may be a beacon signal generator and transmitter 150 that is used so the location of the inspection apparatus can be determined and tracked. The beacon signal can be of different types or electromagnetic radiation, including radio waves and microwaves. Or the beacon signal can be an optical or light signal, which has the advantage of being visible if the inspection apparatus were to be located in a body of the fluid external of the pipeline 92.

One advantage of beacon signals is that they can carry several, constantly changing parameters, such as power-supply information, relative address, location data, timestamp data, signal strength data, temperature data, pressure data, and other information and data.

A power supply in the form of a rechargeable battery 162 is a further additional device. Due to its weight, typically the battery 162 will be located in the chamber 104.

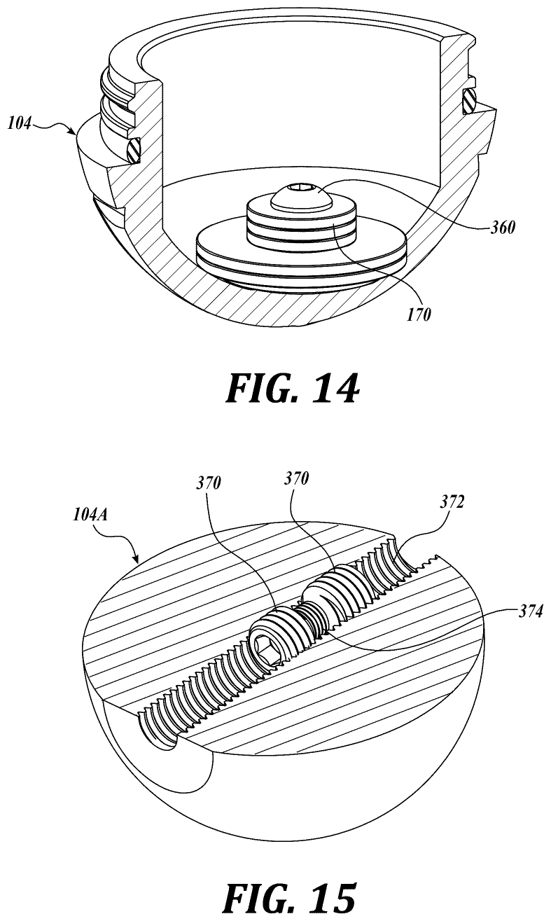

Removeable weights are located in the chamber 104, see FIG. 14. The weights can be in the form of replaceable washers 170 engaged over a post near the bottom of the chamber 104. The washers 170 can be composed of various metals, polymers, or rubber to change the buoyancy of the chamber 104.

The difference of the readings from the sensors of the same type located in the float chamber (102) and the lower housing or chamber (104) is computed. Events that are sensed by both sensors simultaneously can be discounted, while events that are separated in time can be enhanced as each sensor records the event at slightly different moments in time. In this manner, the data from each sensor provides a confirmation of the data from the other sensor or can be eliminated if each sensor records an event (such as an impact on the pipe wall) simultaneously.

As noted above, the inspection system 90 also includes a retrieval unit 200 for retrieving the inspection apparatus 100 from the pipeline flow. As shown in FIGS. 4-12, the retrieval unit 200 includes a foldable catchment device 202 that is nominally disposed in an elongate housing structure 206 that is connectable to the pipeline to extend transversely to the pipeline. When deployed by a deployment device 204, the catchment device is lowered into the pipeline to expand and extend across the top of the pipeline flow to capture the inspection apparatus 100 moving in the pipeline. Thereafter, the deployment device 204 is operable to remove the catchment device 202, together with the inspection apparatus 100, from the pipeline and into the housing structure 206.

As shown in FIGS. 4-9, the catchment device 202 is constructed in the form of a hook 207 composed of two prongs 208 that diverge from a catchment slot 210 that is created by spaced apart sections of the prongs. The proximal ends of the prongs 208 extend downward in spaced parallel relationship along sections 212 from a piston 214 that is snuggly disposed with a cylindrical portion 216 of the housing structure 206. The prongs 208 then curve up diagonally upwardly, still in spaced parallel relationship and then diverge outwardly to define a slot 210. Next, the prongs 208 extend laterally outwardly across the top of the pipeline flow and slightly downwardly from flexible joint corner joints 218. The joints 218 enable the distal ends of the prongs 208 to move towards each other sufficiently to slide into the cylinder portion 216 when the catchment device 202 is raised into the cylinder portion as shown in FIGS. 11 and 12.

FIG. 4 shows the catchment 202 device stored within the housing structure 206 of the deployment device 204. The housing structure 206, as noted above, includes an elongate cylindrical portion 216. A connector 220 is located at the top of the pipeline to attach a valve 222 to the pipeline. The lower end of the housing structure 206 to detachably attached to the valve 222 to provide access to the interior of the pipeline. The valve is usually part of the pipeline appurtenance, such as an air release valve. A viewing window 224 may be located above the valve to enable the interior of the housing structure 206 to be visible from the exterior of the catchment device 202.

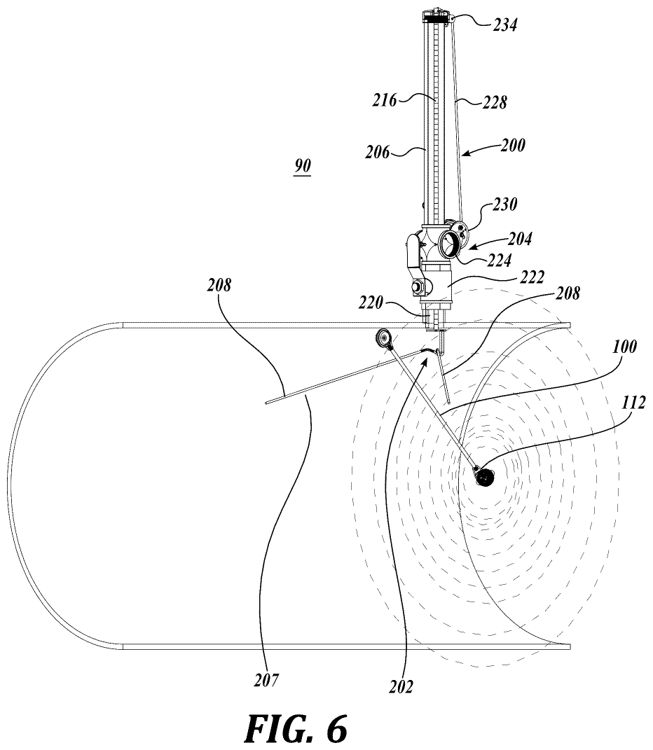

A push rod 226 extends upwardly from the piston 214 a distance sufficient that when the push rod is forced downwardly by line 228, the catchment device 202 is positioned within the upper portion of the pipeline 92 as shown in FIGS. 6-10. The line 228 is spooled on a reel 230 mounted to the exterior of the housing structure 206. A hand crank 232 is provided to operate the reel 230 when deploying the catchment device 202 into the pipeline 92. Also, an idler pulley 234 is located at the upper end of the housing structure 206 to guide the line 228 when the catchment device 202 is being deployed into the pipeline 92.

To briefly describe them operation of the catchment device 202, referring initially to FIG. 4, the housing structure 206 of the catchment device 202 is connected to a fitting located on the top side of the pipeline 92, using the connector 220 of the housing structure. When in place, the housing structure 206 extends upwardly, transversely, from the pipeline, with the catchment device 202 in folded position within the cylindrical portion 216 of the housing structure.

When it is desired to deploy the catchment device 202, the valve 222 is opened and then the hand crank 232 of the reel 230 is operated to force the push rod 226, and thus also the piston 214, downwardly relative to the cylinder 216. As shown in FIG. 5, as the downward sections 212 of the prongs 208 extend below the housing structure 206, the distal ends of the prongs spread apart to be positioned across the top portion of the pipeline come on as shown in FIG. 6. The tension of the line 228 on the upper end of the push rod 226 maintains the catchment device in deployed configuration, or else the pressure of the fluid in the pipeline 92 would force the piston 214, and thus also the catchment device, up into the housing cylinder 216.

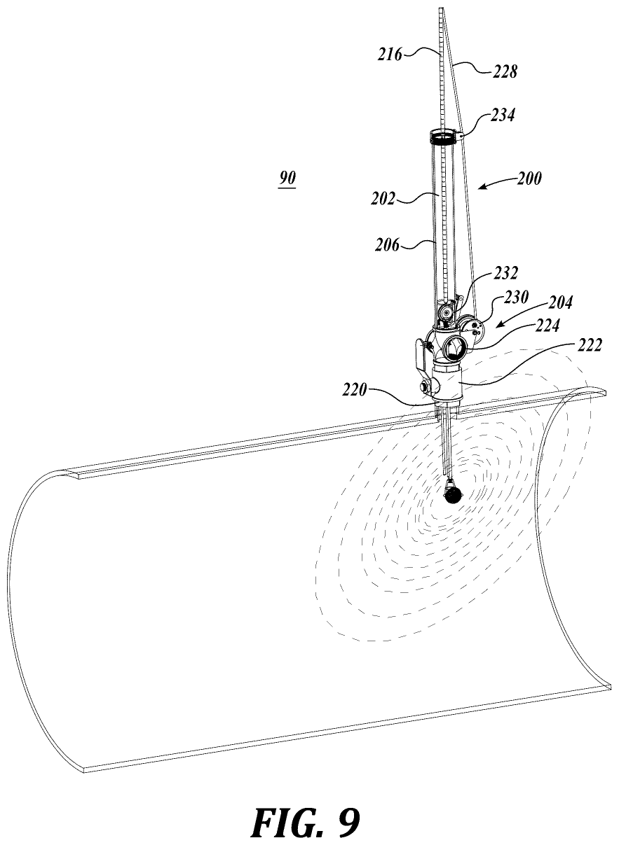

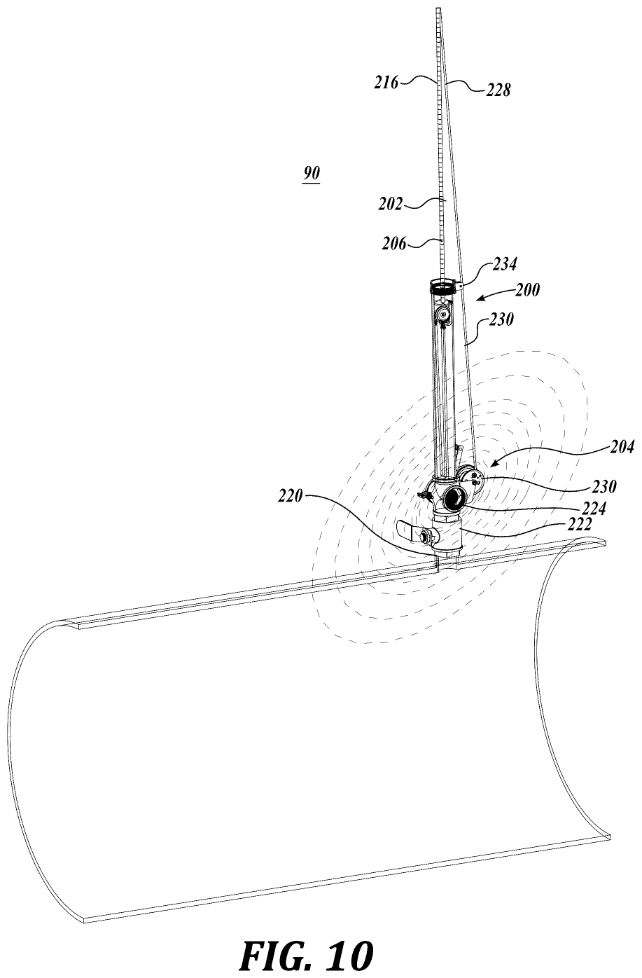

FIGS. 7 and 8 show the inspection apparatus 100 approaching the catchment device 202. In this regard, the chamber 102 of the inspection apparatus 100 is at an elevation above the prongs 208. Also, the divergent distal ends of the prongs are disposed sufficiently across the width of the pipeline to capture the inspection apparatus 100 between the prongs and guide the inspection apparatus toward proximal ends of the prongs so that the connector 106 of the inspection apparatus 100 engages into the slot 210 defined by the proximal ends of the prongs as shown in FIGS. 9 and 10.

Thereafter, the tension on the line 228 is released, whereupon the pressure of the fluid in the pipeline 92 forces the piston 214 upwardly within the cylinder 216, thereby raising the catchment device 202 together with the captured inspection apparatus 100 also into the cylinder 216. Next, the valve 222 can be closed to separate the interior of the housing structure from the pipeline. The catchment device 202 can then be removed from the housing structure 206.

The kit 95 is shown in FIGS. 11 and 12. In basic form, as noted above, the kit 95 is composed of the disassembled inspection apparatus 100 stored in a portable case or cradle 300 having a cover section 310 hinged to a body 312. Both the cover section 310 and the body are filled with foamed rubber having cavities or cut outs for storing the components of the inspection device and other items and tools. The cradle includes a latch to maintain the cover section 310 securely closed. Also, a handle, not visible, is attached to the top of the cover section to conveniently carry the cradle 300.

The upper chamber 102 is shown as stored in cavity or pocket 302, and the lower chamber 104 is shown as stored in a cavity or pocket 304 of the body 312. A wireless charging unit is built into the body 312 and its plug 314 is shown stored in pocket 316 from which the plug can be removed for insertion into a standard electrical outlet.

The kit 95 also includes “dummy” chambers 102A and 104B to be used in place of the chambers 102 and 104. The dummy chambers 102A and 102B are used in place of the chambers 102 and 104 when testing to make sure that the inspection apparatus 100 is able to travel with the flow in the pipeline 92. In this regard, the dummy chambers 100A and 100B are devoid of sensing devices or additional devices, with the exception of a beacon generator and transmitter 150. As noted above, the travel of the beacon generator and transmitter 150 through the pipeline can be monitored for obstructions, such as debris, in the pipeline or other conditions that would note enable the inspection apparatus to successfully pass through the pipeline. Such other conditions can include, for example, tubercules, fats/oils/greases, silt build up or struvite. The dummy chambers 102A and 102B are also stored in the case body 312 in pockets 320 and 322.

Silicon socks 330 are stored in the case body in pocket 332. The silicon socks can be used to encase the inspection apparatus 100 to help protect the apparatus from shock loads encountered during travel in the pipeline. The sock does not cover the odometer/speedometer wheel, which needs to be free to roll along the pipeline surface.

FIG. 13A shows the use of wrenches 340 to open and close the chambers 102 and 104. A pocket 342 is formed in the foam positioned in the lid 310, for convenient storage of the wrenches. With the wrenches 340 engaged with the chambers 102 and 104, the two sections of the chambers can be unscrewed relative to each other, as shown in FIG. 13B, to gain access to their interiors, for example, to remove the SD card 160 or to charge the battery 162. In this regard, the wrenches have flats 344 that correspond with the segments 108 that compose the sections of the chambers 102 and 104.

As indicated in FIG. 13B, when the chambers 102 and/or 104 have been opened, a plate 350 is exposed. To charge the battery 162, the plate 350 is placed over a charging pad located in the base of pocket 304. When the plate 350 is in contact with the charging pad, charging of the battery automatically begins. Although not shown in the Figures, the storage unit can be constructed with its own battery that can be used to charge the battery 162 if a source of electricity is not available to the plug 314.

When the chamber 104 is opened, access is provided to the buoyancy weights 170, which are located in the lower semisphere of the chamber. The washer weights are engaged over a center post and a cap 360 is securable to the post of maintain the washer weights fixed in place. The buoyancy of the chamber 104 can be adjusted by changing the number of weight washers used and/or the material comprising the weight washers, as noted above.

Of course, the other types of weights can be used. Further, if the chamber 104 is constructed in a sealed manner, the chamber and the buoyancy weights can be designed to be accessed from the exterior of the chamber.

As shown in FIG. 15, the buoyancy of the dummy chamber 104A also can be adjusted. In this regard, two set screws 370, having hexagonal center sockets, are engaged with threads 372 to extend across the diameter of the chamber. The set screws 370 capture weight washers 374 therebetween. The buoyancy of the dummy chamber 104 can be altered by change the number of washers 374 and/or the material from which the washers are composed. Also, if desired plugs can be inserted into the ends of threads 372 to coincide with the exterior of the dummy chamber 104A.

While illustrative embodiments have been illustrated and described, it will be appreciated that various changes can be made therein without departing from the spirit and scope of the invention. For example, rather than using a single negative buoyancy chamber 104, more than one negative buoyancy chamber can be used. Also, a flexible and/or collapsable connector can be used between the negative and positive buoyancy chambers.

Further, the storage unit or cradle 300 and the inspection apparatus 100 can be designed so that the sensing devices automatically turn on when removed from the cradle and continue to sense and record the sensor information until they are returned to the cradle.

The embodiments of the invention in which an exclusive property or privilege is claimed are defined as follows:

1. An inspection apparatus to inspect the condition of a conduit, the inspection apparatus flowing with a fluid within the conduit, the inspection apparatus comprising:
first and second chambers interconnected together in spaced apart relationship, one of the chambers is positively buoyant and the other chamber is negatively buoyant;
sensing devices to detect and sense physical parameters of at least one of the fluid and the conduit are disposed within at least one of the first and second chambers.

2. The inspection apparatus of claim 1, further comprising additional devices to operate the sensing devices, the additional devices comprising at least one of a signal transmitter, a data signal transmitter, a beacon signal generator and transmitter, a light transmitter, a data recorder, and a power supply disposed in at least one of the first and second chambers.

3. The inspection apparatus of claim 1, wherein the sensing devices are selected from the group consisting of:
an acoustic leak noise detector;
an ultrasonic wall thickness transducer;
a fluid pressure sensor;
a CCTV camera;
inertial measurement units;
sonar equipment;
LiDAR equipment;
electromagnetic sensors to measure residual magnetic memory;
speedometer;
odometer.

4. The inspection apparatus of claim 1, further comprising a connector for interconnecting the first and second chambers at a distance from each other.

5. The inspection apparatus of claim 4, wherein the connector is of a construction selected from substantially rigid, semi rigid, and flexible.

6. The inspection apparatus of claim 4, wherein the connector is of a length that when the apparatus is moving with the flowing fluid in the conduit, the negatively buoyant chamber is approximate at the vertical center of the flowing fluid.

7. The inspection apparatus of claim 6, wherein the connector is adjustable in length.

8. The inspection apparatus of claim 4, wherein the connector at its juncture with the negatively buoyant chamber is aligned away from the centroid of the negatively buoyant chamber.

9. The inspection apparatus of claim 4, further comprising a keel structure located at or near the negatively buoyant chamber to assist in aligning the apparatus relative to the direction of the flow in the conduit.

10. The inspection apparatus of claim 1, further comprising removable ballast disposable in the negatively buoyant chamber.

11. The inspection apparatus of claim 1, wherein one or both of the chambers are of a shape selected from the group consisting of a sphere, spheroid, prolate spheroid, oblate spheroid, ovoid, platonic sphere, polyhedron, octahedron, dodecahedron, icosahedron.

12. The inspection apparatus of claim 1, further comprising an odometer/speedometer wheel rotatable relative to the positively buoyant chamber to project beyond the exterior of the positively buoyant chamber.

13. The inspection apparatus of claim 12, wherein the positively buoyant chamber comprises two sections and the odometer wheel is disposed between the two sections of the positively buoyant chamber.

14. The inspection apparatus of claim 12, further comprising an encoder associated with the odometer wheel to sense the distance travelled by the apparatus.

15. A system for inspecting the condition of a conduit while fluid is flowing in the conduit, comprising the inspection apparatus of claim 1, and a retrieval unit insertable into the conduit for catching the inspection apparatus and removing the inspection apparatus from the conduit.

16. The system of claim 15, wherein the retrieval unit comprising:
a catchment device shaped to capture the inspection apparatus, and
a deployment device to deploy the catchment device across the width of the conduit near the top of the flow level of the fluid flowing through the conduit.

17. The system of claim 16, wherein the catchment device comprises a hook with diverging prongs, the prongs diverging from a juncture.

18. The system of claim 17, wherein the retrieval unit comprising a housing structure connectable to an opening in the conduit to extend transversely from the conduit, the catchment device nominally disposable in the housing.

19. A kit for inspecting the condition of a conduit while fluid is flowing in the conduit, comprising the inspection apparatus of claim 1, and a portable storage and carrying cradle, the cradle comprising:
pockets for snugly receiving and holding the chambers of the inspection apparatus; and
an electrical charging system for charging the sensing devices and additional devices disposed in one or both of the negatively and positively buoyant chambers.

20. The kit of claim 19, wherein the electrical charging system is configured to automatically begin charging the sensing devices and additional devices when the negatively and/or positively buoyant chambers are placed in the pockets of the cradle.
